(19) United States
(12) Patent Application Publication
(10) Pub. No.: US 2014/0066139 A1
(43) Pub. Date: Mar. 6, 2014

(54) Interface with and communication between mobile electronic devices

(71) Applicant: Michael J. Ure, Cupertino, CA (US)

(72) Inventor: Michael J. Ure, Cupertino, CA (US)

(21) Appl. No.: 13/968,728

(22) Filed: Aug. 16, 2013

Related U.S. Application Data
(63) Continuation of application No. 11/888,811, filed on Aug. 1, 2007.

(51) Int. Cl. H04M 1/02

(52) U.S. Cl. CPC H04M 1/026
USPC 455/575.1

(57) ABSTRACT

An input device and mobile electronic devices having improved user interface capabilities are described. In one embodiment, an input device includes a display device, a capacitive touch sensor overlying the display device, and a pressure-sensing layer underlying the display device. The display device may be, for example, a cholesteric liquid crystal display that directly captures and displays writing in response to applied pressure. Such an input device may be used to greatly facilitate input of text and graphical information to mobile electronic devices. In another embodiment, a mobile electronic device includes a first housing portion and a second housing portion connected together in a hinged manner, a display housed by the first housing portion, and a pressure-sensing layer housed by the second housing portion for performing writing capture in response to a stylus.

### BACKGROUND

1. Field of the Invention

The present invention relates to interface with and communication between mobile electronic devices such as cell phones.

2. State of the Art

User input to mobile electronic devices such as cell phones has been limited, by the limited size and capabilities of such devices. Such devices are typically limited to text input and to “linear” graphical user interfaces. Some devices have “mini-QWERTY” keyboards, or thumb pads, wherein separate keys are provided for each letter of the alphabet. These devices tend to be wider than other devices and less comfortable to hold to ones ear for conversation. In other devices, multiple letters share a single key. Text input using these devices tends to be cumbersome. Some devices use no keys at all but use only a touch screen. Tactile feedback is therefore lost.

### SUMMARY

An input device and mobile electronic devices having improved user interface capabilities are described. Text and graphics input, graphical user interface operation, and messaging capabilities are significant areas of focus. In one embodiment, an input device includes a display device, a capacitive touch sensor overlying the display device, and a pressure-sensing layer underlying the display device. The display device may be, for example, a cholesteric liquid crystal display that directly captures and displays writing in response to applied pressure. Such an input device may be used to greatly facilitate input of text and graphical information to mobile electronic devices. In another embodiment, a mobile electronic device includes a first housing portion and a second housing portion connected together in a hinged manner, a display housed by the first housing portion, and a pressure-sensing layer housed by the second housing portion for performing writing capture in response to a stylus. In another embodiment, a method of sending a message includes establishing a communication session, capturing stylus input, and as part of the communications session, sending a representation of the captured stylus input. The representation may be a textual representation or a graphical representation. The graphical representation may be sent in real time and displayed as a succession of images, each successive image updating a prior image, and the communications session may include voice communications.

### DESCRIPTION OF DRAWING

The foregoing may be further understood from the following description conjunction with the appended drawing. In the drawing:

FIG. 1 is a block diagram of a mobile electronic device having improved user interface capabilities.

FIG. 2 is a diagram of an input device that may be used with the mobile electronic device of FIG. 1.

FIG. 3 is plan view of a portion of a mobile electronic device such as the mobile electronic device of FIG. 1 in one configuration thereof.

FIG. 4 is diagram of a keypad overlay that may be used with the mobile electronic device of FIG. 1.

FIG. 5 is plan view of a portion of a mobile electronic device such as the mobile electronic device of FIG. 1 in another configuration thereof.

FIG. 6 is a plan view of a keypad overlay that may be used with the device of FIG. 5.

FIG. 7 is a perspective view illustrating key operation of the device configuration of FIG. 3 using both thumbs.

FIG. 8 is a perspective view illustrating key operation of the device configuration of FIG. 3 using a stylus.

FIG. 9 is a perspective view illustrating touch operation of the device configuration of FIG. 3 using a finger.

FIG. 10 is a perspective view illustrating key operation of the device configuration of FIG. 5 using both thumbs.

FIG. 11 is another perspective view illustrating key operation of the device configuration of FIG. 5 using both thumbs.

FIG. 12 is a perspective view illustrating touch operation of the device configuration of FIG. 5 using a finger.

FIG. 13 is a perspective view illustrating removal of a keypad overlay from the device configuration of FIG. 3 using thumb and forefinger.

FIG. 14 is a plan view of mobile electronic device provided with an input device like that of FIG. 2.

FIG. 15 is a cross-sectional view of an alternative construction of an input device like that of FIG. 2.

FIG. 16 is a flowchart illustrating text entry.

FIG. 17 is a flowchart of mobile instant messaging using text entry in accordance with FIG. 16.

FIG. 18 is a flowchart of enhanced mobile instant messaging.

FIG. 19 is a flowchart of further enhanced mobile instant messaging.

FIG. 20 is a flowchart of enhanced voice communications.

FIG. 21A is a first diagram illustrating mobile instant messaging using text and graphics input in accordance with FIG. 18.

FIG. 21B is is a second diagram illustrating mobile instant messaging using text and graphics input in accordance with FIG. 18.

FIG. 21C is is a third diagram illustrating mobile instant messaging using text and graphics input in accordance with FIG. 18.

FIG. 22 is a stylus that may be used with a “plain paper input” method.

FIG. 23 is a diagram illustrating plain paper input.

### DETAILED DESCRIPTION

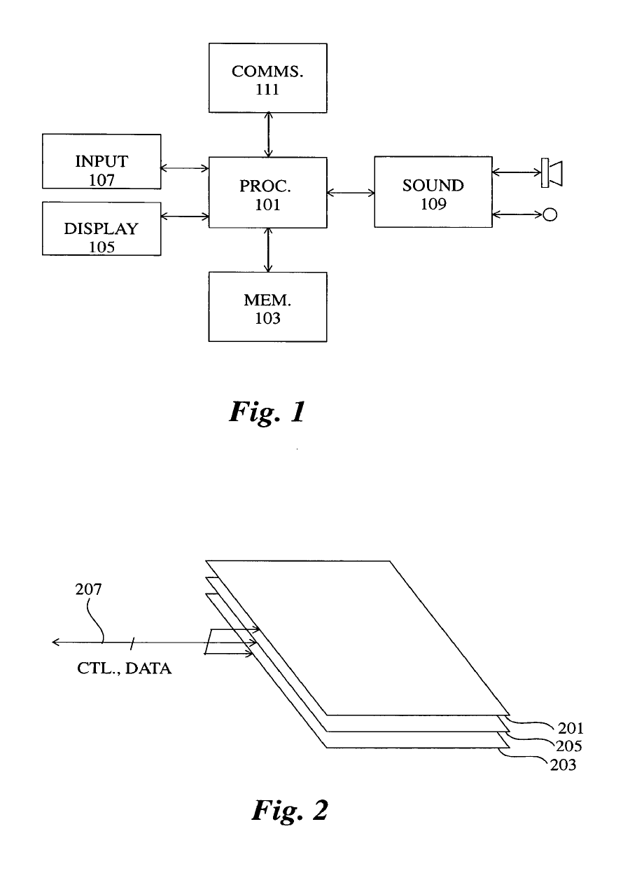

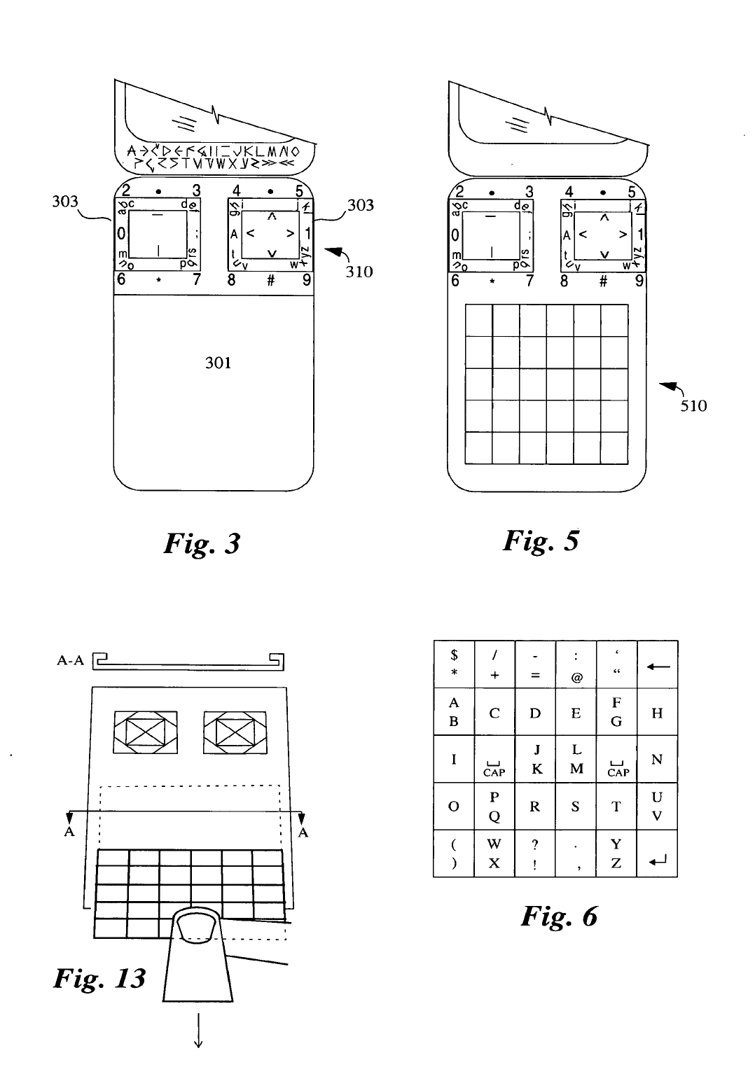

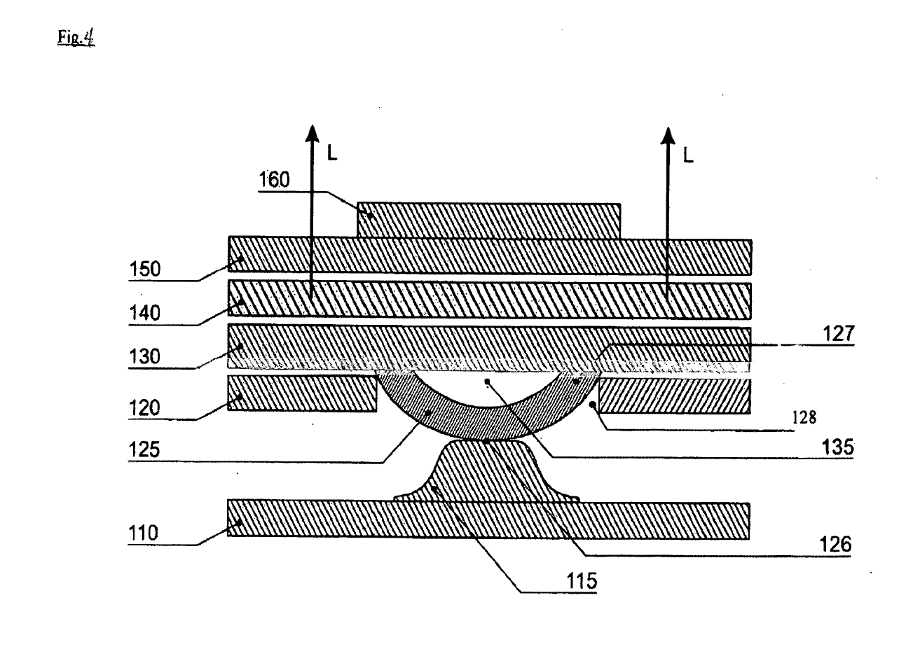

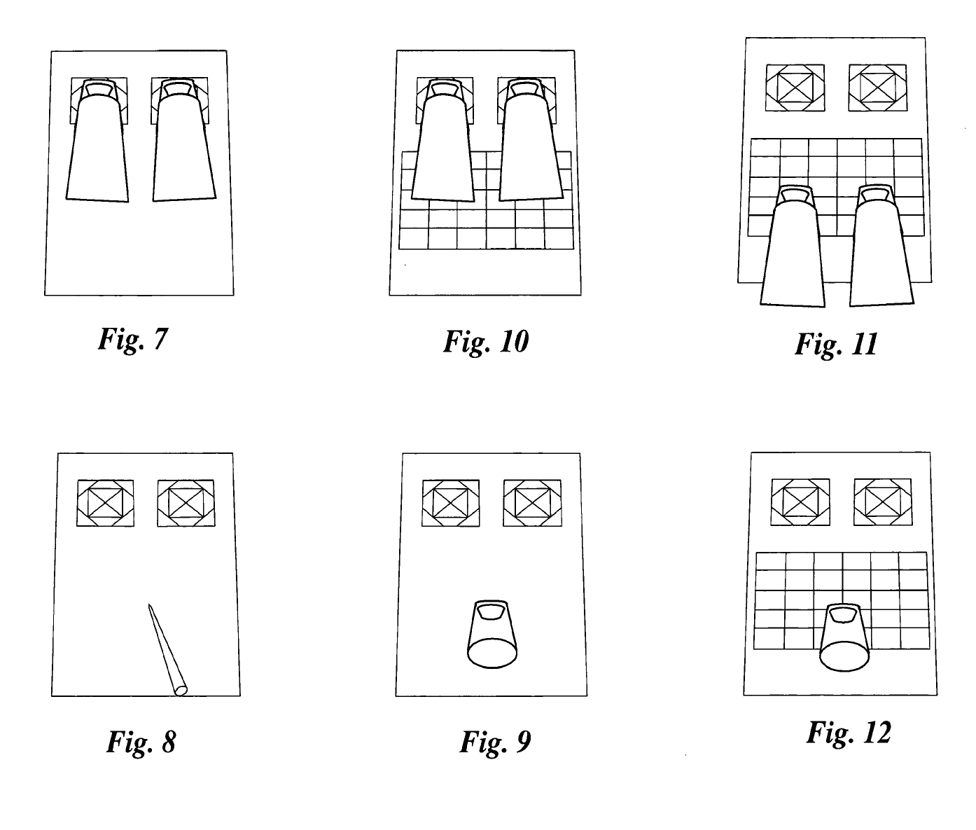

Referring now to FIG. 1 a block diagram is shown of a mobile electronic device having improved user interface capabilities. A processor 101 is coupled to memory 103, to a display sub-system 105, and to an input sub-system 107, described more fully hereinafter. The processor is also coupled to a sound sub-system 109 and a communications sub-system 111.

The input sub-system 107 of the mobile electronic device of FIG. 1 preferably includes an input device having both touch input and stylus input capabilities as well as certain display capabilities. One example of such a device is shown in FIG. 2. A clear capacitive touch sensor 201 is provided overlying a resistive sensor or other stylus—responsive sensor 203. Between the capacitive touch sensor 201 and the resistive sensor 203 is provided a display film 205. Control and data signals are exchanged with the input device through a bus 207. A suitable clear capacitive touch sensor 201 is available from Alps Electric of Japan, for example. Such a sensor is constructed by embedding transparent (e.g., indium tin oxide, or ITO) electrodes within a polycarbonate layer. Preferably, the polycarbonate layer is made thinner than normal in order to affect the response of the display film 205 and the resistive sensor 203 as little as possible.

The positions of the display film 205 and the resistive sensor 203 may be interchanged so long as the resistive sensor 203 is made clear allowing the display film 205 to be viewed through it.

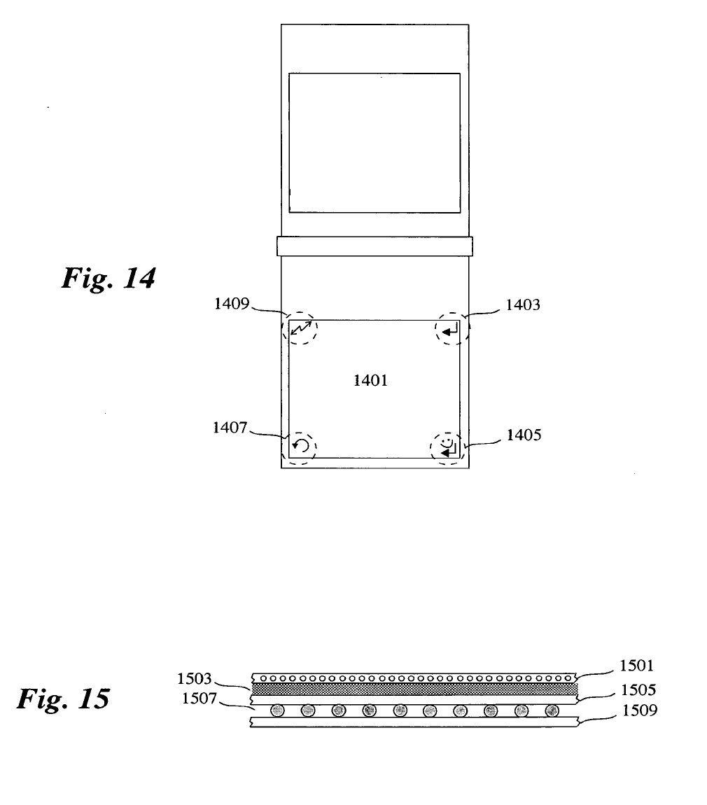

Referring to FIG. 14, a plan view of shown of a mobile electronic device that includes an input device 1401 like that of FIG. 2. The input device is provided in the corners thereof with indicia that serve as user interface icons used for writing capture. Pressing on an icon causes an action to be performed. In an exemplary embodiment, the icons perform the following actions. 1. Icon 1403: Input, recognize (convert to text) and optionally send to a remote user the text written on the input device; clear the display of the input device. 2. Icon 1405: Input and optionally send to a remote user the text or graphics written on the input device (do not perform recognition); clear the display of the input device. 3. Icon 1407: Clear the display of the input device. 4. Icon 1409: Enable communication of stylus input to a remote user in real time. Of course, other specific indicia (icons) and other specific functions may be provided in lieu of or in addition to those described.

Referring again to FIG. 2, the display film 207 may be a plastic substrate cholesteric LCD (ChLCD) display film of a type available from Kent Displays Incorporated of Kent Ohio, USA. ChLCDs offer certain advantages in the application of a mobile electronic device. In an exemplary embodiment, the display is a “single-pixel” ChLCD, resulting in low cost. Where cost is not so great an issue, however, the ChLCD display may be a QVGA or similar type of medium or high resolution display. ChLCD displays are low-power, an important characteristic in mobile applications. They are non-volatile, meaning that display content is persistent without the need for display refresh. Furthermore, they do not require backlighting. Backlights consume considerable power. Finally, for writing capture, a ChLCD configured as described provides immediate response without the need for processor intervention.

Other types of displays, however, including color STN LCD displays, OLED displays, or other color flat-panel displays, may also be used to advantage where cost and power are not so constrained. OLED displays may be particularly well-suited because of their compatibility with plastic substrates. The use of a full-resolution (rather than “single-pixel”) display enables interactive touchpad operation. That is, the touchpad becomes a touchscreen. Of course, medium and high resolution color displays are also visually attractive to the user.

The input device of FIG. 2 may be further optimized for cost reduction and performance. Referring to FIG. 15, a layer 1501 contains embedded ITO electrodes and is used for capacitive touch sensing. In some embodiments, the same ITO electrodes may be used driven by a display driver to produce an image. Beneath the layer 1501 is liquid crystal (e.g., cholesteric liquid crystal) 1503. A layer 1505 cooperates with the layer 1501 to form an envelope for the liquid crystal 1503. The layer 1505 is clear and is provided on the bottom with a coating of conductive paint or ink of a color the same as the desired display color. The coating is connected to electrical ground and also serves as a grounding layer for the resistive sensor. The layer 1509 is a sense layer of the resistive sensor. Between the layers 1505 and 1509 is a layer of elastomeric spacers 1507. By reducing the number of layers of material, cost may be reduced and responsiveness increased.

Referring now to FIG. 3, a plan view is shown of one configuration of a portion of a mobile electronic device such as the mobile electronic device of FIG. 1. The mobile electronic device is assumed to use an input device 301 like the input device of FIG. 2. In this configuration, a keypad overlay 310 (to be described) overlies an upper portion of the input device of FIG. 2. A lower portion of the input device remains exposed.

In the illustrated embodiment, the keypad overlay defines two “key complexes” 303 and 305 each of which may be imagined as a four-way rocker switch nested within an eight-way rocker switch for a total of 24 switch inputs. The key complexes exhibit bi-axial symmetry about orthogonal axes. (In other embodiments, the key complexes may actually be realized in the form of rocker switches instead of in the form of a keypad overlay.) FIG. 3 illustrates one example of how indicia may be provided on the keys of the key complexes. Twelve of the keys (0-9, * and #) correspond generally to the number keys and associated keys (*, #) of a typical cell phone. Four of the keys (̂, v, <, >) correspond generally to up, down, left, right keys. Of these same keys, the up arrow may be colored green to allow this same key to be used as the SEND key following entry of a number. The down arrow may be colored red to allow this same key to be used as the END key at the conclusion of a call.

Two upper middle keys (*) are used as “softkeys.” Two keys bear the indicia “|” and “—” respectively. Together with the up, down, left and right keys, these keys may be used to implement the ClickText™ text entry system, described in U.S. Patent Publication 20030030573, incorporated herein by reference. In the ClickText text entry system, two successive key presses are used to unambiguously identify each letter of the alphabet, enabling no-look touch typing. The key combinations are chosen so as to bear a strong resemblance to the capital form of the letter being entered (e.g., ̂ then — for A). Two keys (;, A) are used for punctuation and case selection. Two keys bear no indicia and are available for other uses.

Although the foregoing key configuration is believed to be advantageous, many other key configurations are also possible.

A keypad overlay is a keypad structure that during use overlies and cooperates with one or more underlying sensors such as the sensors of FIG. 2. The keypad overlay lacks electrical circuits that are closed or opened to cause current to flow or not flow depending on a state of depression of the key domes. Instead, operation of the keys of the keypad overlay is sensed by the underlying sensor(s). As a result, the keypad overlay is removable, and may be interchanged with any of a variety of interchangeable keypad overlays. Keypad overlays may be provided that are specific to a company or team, specific to an application, etc. Unlike software keyboards, tactile feedback is preserved.

When such interchanging of keypad overlays is performed, the change must be communicated to the device software so that the software can correctly sense and interpret key presses. The change can be communicated manually by the user or may be communicated automatically by features of the keypad overlay. For example, the keypad overlay may have the electrical equivalent of a bar code pattern embedded therein and coupled upon insertion into the device to a reference potential (e.g., ground). The capacitive touch sensor may sense the pattern to identify the particular keypad overlay. Alternatively, the device may be provided with Near Field Communications (NFC) capability, and the keypad overlay may have a RFID tag or the like embedded therein.

A suitable keypad overlay may be formed by adapting the teachings of U.S. Patent Publication 20060042923 of De Richecour, assigned to Molex Inc., incorporated herein by reference. Referring to FIG. 4 (corresponding generally to FIG. 2 of De Richecour), an actuator layer is made of a thin plastic film 110 with actuator pins or plungers 115 injected. On the actuator layer 110 are stacked respective layers including: a dome layer comprising a dome support plastic foil 120 supporting a plurality of metal domes 125; a layer of a flex foil 130; an optional layer of an electro-luminescent foil 140; and a layer of a graphic foil 150. On top of the graphic layer 150, at the precise position of the key area, an additional UV ink layer 160 is optionally screen printed for simulating a key button and to tactile engagement with the fingers when touching the key area Alternatively, a thin thermoformed plastic layer or the like may be provided having elevated key-shaped regions. Note that the circuit layers 131 and 132 of De Richecour are eliminated.

The edges of the keypad overlay are finished using a suitable technique to render them resistant to wear. Preferably, the actuator layer 110 is provided with moderate stiffness so that the keypad overlay retains in substantial degree its planar form when it is withdrawn from the device.

The mobile electronic device may be provided with a “track” into which the keypad overlay is slideably inserted or from which the keypad overlay is slideably removed. Multiple keypad overlays may be used together. If desired, a plastic trim piece may be provided that snaps or slides into the track and covers the bottom edge of one keypad overlay and the top edge of the next keypad overlay so that multiple keypad overlays may be used together without detracting from the aesthetics of the device.

Instead of a keypad overlay, an overlay may in fact not define any keys at all but simply be a touchpad overlay that defines touch areas for a particular application.

Referring again to FIG. 3, it is expected that the keypad overlay 310 would ordinarily be present and would be removed or interchanged infrequently or not at all. In fact, the same or similar key arrangement could he provided in conventional fashion instead of in the form of a keypad overlay. However, a keypad overlay is believed to be advantageous from the standpoint of device construction. Circuit board area that would otherwise be devoted to key contacts may be saved. The design of the plastic of the mobile electronic device may be simplified.

The device configuration of FIG. 3 allows for three different types of user input, or user actions: Click, Write, Point. “Click” refers to key input, illustrated in FIG. 7. “Write” refers to stylus input, illustrated in FIG. 8. The user may use a stylus to write on the surface, the writing being displayed by the ChLCD (for example) and captured by the pressure-sensing layer. “Point” refers to cursoring, navigation and control input using finger, thumb, or both (multi-touch), illustrated in FIG. 9. Touch inputs are sensed by the capacitive touch sensor.

A further device configuration is illustrated in FIG. 5. In this configuration, a second keypad overlay 510 is provided to allow for “Blackberry™-like” text input. In the illustrated embodiment, the second keypad overlay is six keys wide (instead of ten keys wide as is often used). As illustrated in greater detail in FIG. 6, the letters are therefore arranged alphabetically instead of in QWERTY fashion. Some keys bear more than one letter. The letters may be selected between using “touch inflections.” For example, when the lower letter of two letters is desired, the key is pressed and coincident with release of the key, the digit used to depress the key is drawn slightly toward the user. The capacitive touch sensor is able to sense this touch inflection and thereby select the correct letter or other character.

The configuration of FIG. 5 allows for user actions of Click and Point. Key input may be performed using either the first keypad overlay (FIG. 10) or the second keypad overlay (FIG. 11). Pointing may be performed “through” the keypad overlay 510, which is sufficiently thin and sufficiently non-conducting as to not significantly interfere with operation of the capacitive touch sensor, as illustrated in FIG. 12. This configuration typically does not allow for the user action of Write, because of surface contours and sub-surface obstructions of the keypad overlay.

The second keypad overlay 510 may be “stowed” on the rear surface of the mobile electronic device, for example within a track provided on the battery cover lid, when not in use. The keypad overlay 510 is then conveniently available and may be quickly unstowed and slid into place for operation. FIG. 13 illustrates removal of the second keypad overlay 510 for subsequent stowing.

The enhanced user input capabilities of the present mobile electronic device enable facile input of both text and graphics.

Because of the non-volatile nature of ChLCD displays, it conveniently serves as a scratchpad/memo-pad. No power is required to preserve the displayed information. An option may be provided to capture and save the displayed information.

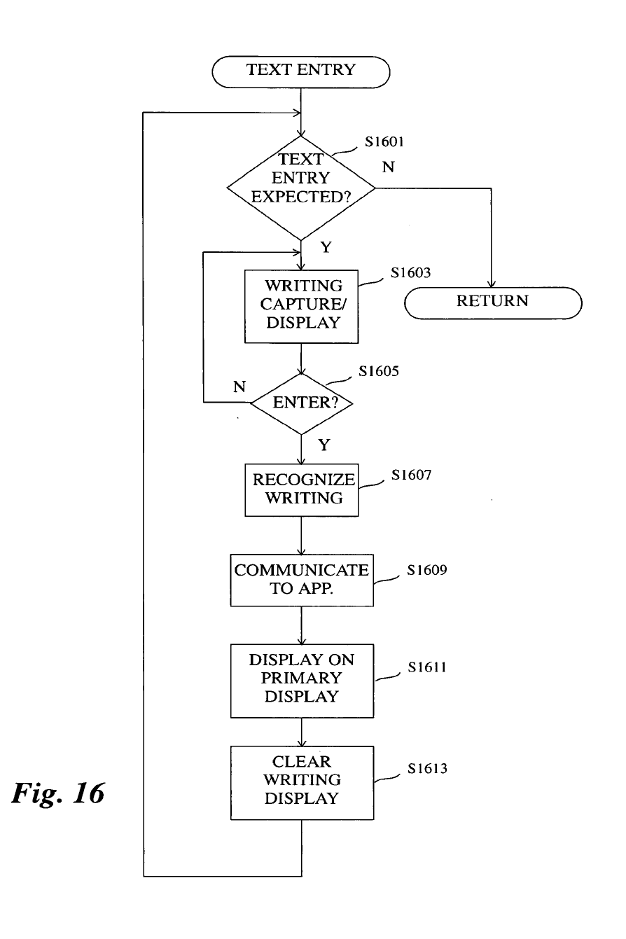

Text entry is made much more facile and rapid. Referring to FIG. 16, in step 1601, the program checks to see whether text entry is expected. If not, program flow returns. If so, writing capture/display is performed (S1603). In step S1605, the program checks to see whether an action equivalent to pressing ENTER on a keyboard has been performed, for example activating the icon 1403 (FIG. 14). If not, writing capture/display continues. If so, recognizer software processes the captured input to recognize the user's writing and convert it to text (S1607). The text is communicated to the current application (S1609) and displayed on the primary display (S1611). The writing display is then cleared (S1613). The same flow is then repeated.

Various text recognition modes may be provided suited to handwriting styles having varying degrees of distinctness. Users with a fairly distinct hand should be able to write freely, activating the icon 1403 (FIG. 14) when the available writing space is filled. Other users may benefit from additional assistance. For example, a “word-at-a-time” mode may be provided in which the user activates the icon 1403 following each word. Segmenting input by word aids the recognizer to accomplish accurate recognition. Also, a “dotting” mode may be provided in which the user writes a dot following each word, to the same effect. For users having handwriting that is overly difficult to recognize, the user may activate the icon 1405, causing the handwriting to be stored and/or sent as an image without recognition.

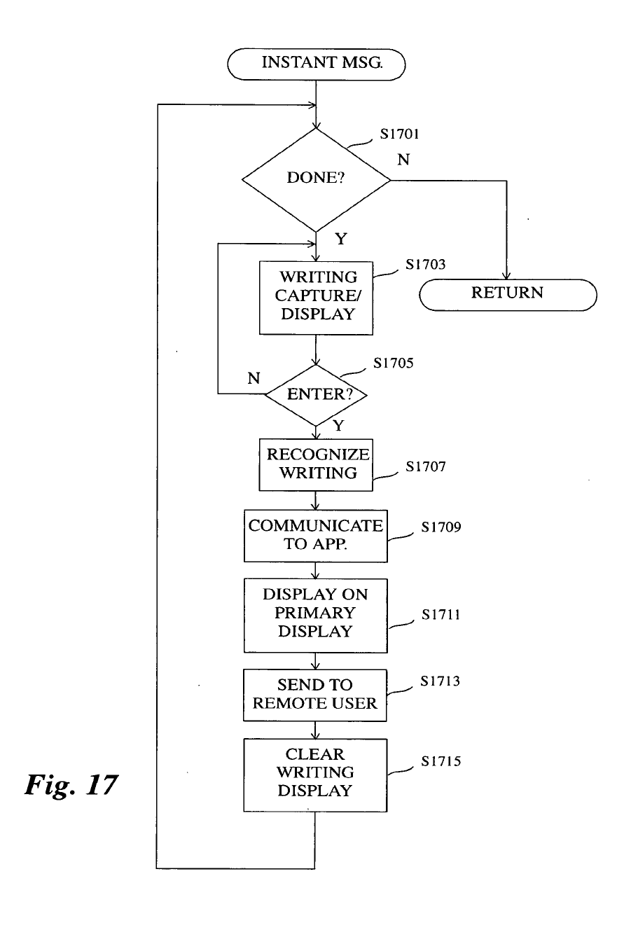

Enhanced text entry capabilities find particular use in mobile instant messaging. Referring to FIG. 17, in step S1701, the program checks to see whether it is finished. If so, program flow returns. If not, writing capture/display is performed (S1703). In step S1705, the program checks to see whether an action equivalent to pressing ENTER on a keyboard has been performed, for example activating the icon 1403 (FIG. 14). If not, writing capture/display continues. If so, recognizer software processes the captured input to recognize the user's writing and convert it to text (S1707). The text is communicated to the current application (S1709) and displayed on the primary display (S1711). The text is communicated to a remote user as part of an instant messaging session (S1713). The writing display is then cleared (S1615). The same flow is then repeated.

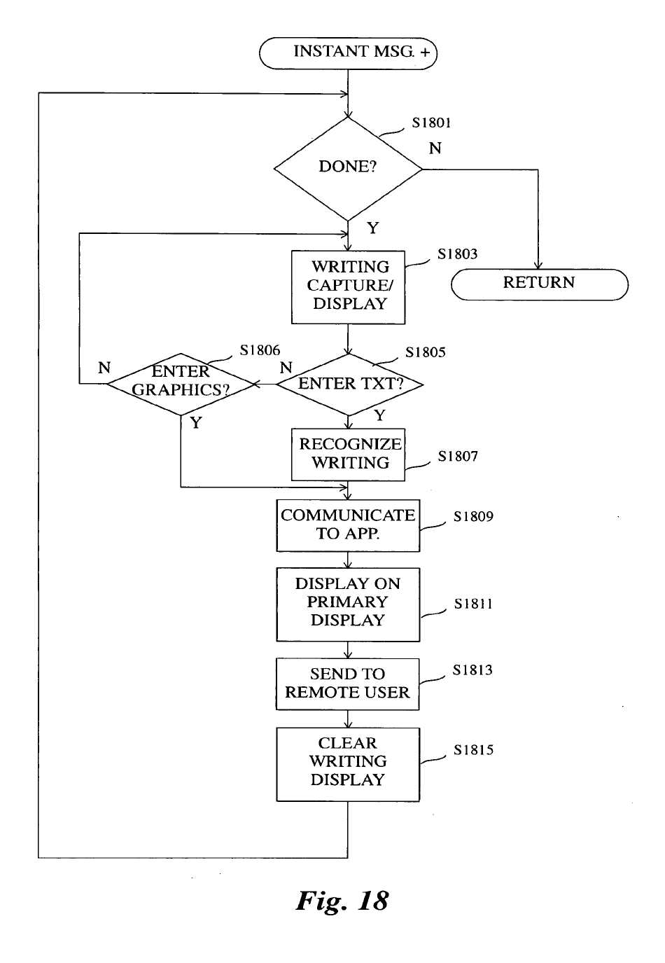

Mobile instant messaging may be further enhanced by provided for graphics (Instant Messaging™). Referring to FIG. 18, in step S1801, the program checks to see whether it is finished. If so, program flow returns. If not, writing capture/display is performed (S1803), In step S1805, the program checks to see whether an action equivalent to pressing ENTER on a keyboard has been performed, for example activating the icon 1403 (FIG. 14). If so, recognizer software processes the captured input to recognize the user's writing and convert to text (S1807). If not, the program further check to see whether an action for entering graphics has been performed, for example activating the icon 1405 (FIG. 14). If not, writing capture/display continues. The text or graphics is communicated to the current application (S1809) and displayed on the primary display (S1811). The text or graphics is communicated to a remote user as part of an instant messaging session (S1813). The writing display is then cleared (S1815). The same flow is then repeated.

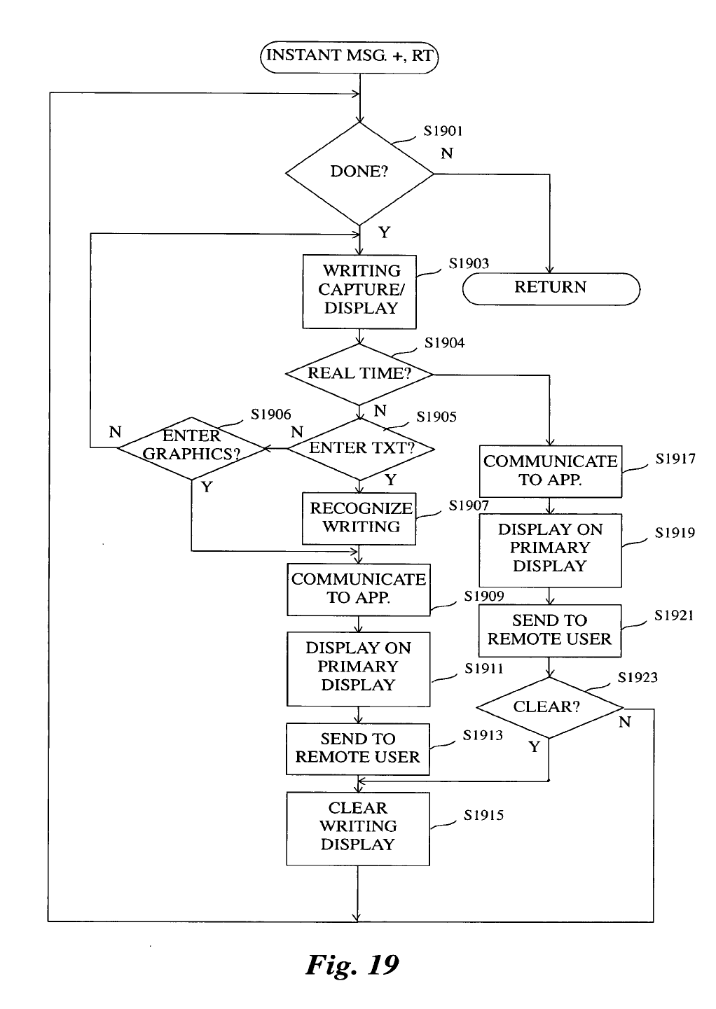

Instead of graphics information being communicated to the remote user at the command of the user, it may be communicated to the remote user in real time. An element of anticipation is created as the remote user observes in real time another user producing a graphic or drawing. Such real time communication of graphics information may be performed by adapting or extending existing messaging protocols. Referring to FIG. 19, in step S1901, the program checks to see whether it is finished. If so, program flow returns. If not, writing capture/display is performed (S1903). In step S1904, the program checks to see whether a real time mode is in effect.

If not, a first series of steps ensues. In step S1905, the program checks to see whether an action equivalent to pressing ENTER on a keyboard has been performed, for example activating the icon 1403 (FIG. 14). If so, recognizer software processes the captured input to recognize the user's writing and convert it to text (S1907). If not, the program further check to see whether an action for entering graphics has been performed, for example activating the icon 1405 (FIG. 14). If not, writing capture/display continues. The text or graphics is communicated to the current application (S1909) and displayed on the primary display (S1911). The text or graphics is communicated to a remote user as part of an instant messaging session (S1913). The writing display is then cleared (S1915). The same flow is then repeated.

If in step S1904 real time mode is found to be in effect, a second series of steps ensues. Graphics information is communicated to the current application (S1917) and displayed on the primary display (S1919). The graphics information is communicated to a remote user as part of an instant messaging session (S1921). The program then checks to see whether an action for clearing the writing display has been performed, for example activating the icon 1407 (FIG. 14). Depending on whether the action for clearing the writing display has been performed, the writing display is either cleared (S1915) or not cleared. The same flow is then repeated.

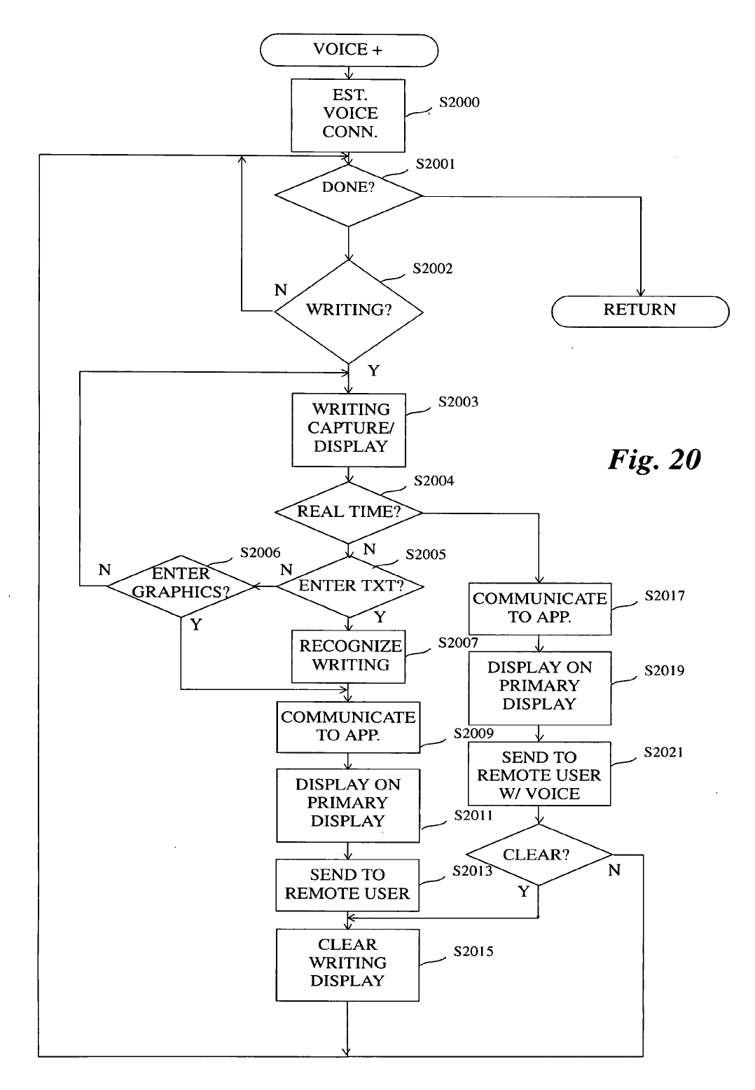

Voice communications may also be enhanced by simultaneous communication of text or graphics (Voice Plus™). Referring to FIG. 20, first, in step S2000, a voice connection is established. Then in step S2001, the program checks to see whether it is finished. If so, program flow returns. If not, the program check to see whether writing has been initiated (S2002). If not, the program again checks to see whether it is finished (S2001). If writing has been initiated, then writing capture/display is performed (S2003). In step S2004, the program checks to see whether a real time mode is in effect.

If not, a first series of steps ensues. In step S2005, the program checks to see whether an action equivalent to pressing ENTER on a keyboard has been performed, for example activating the icon 1403 (FIG. 14). If so, recognizer software processes the captured input to recognize the user's writing and convert it to text (S2007). If not, the program further check to see whether an action for entering graphics has been performed, for example activating the icon 1405 (FIG. 14). If not, writing capture/display continues. The text or graphics is communicated to the current application (S2009) and displayed on the primary display (S2011). The text or graphics is communicated to a remote user as part of an instant messaging session (S2013). The writing display is then cleared (S2015). The same flow is then repeated.

If in step S2004 real time mode is found to be in effect, a second series of steps ensues. Graphics information is communicated to the current application (S2017) and displayed on the primary display (S2019). The graphics information is communicated to a remote user as part of an instant messaging session (S2021). The program then checks to see whether an action for clearing the writing display has been performed, for example activating the icon 1407 (FIG. 14). Depending on whether the action for clearing the writing display has been performed, the writing display is either cleared (S2015) or not cleared. The same flow is then repeated.

The simultaneous communication of voice and graphics may be accomplished, for example, using the technique of U.S. Patent Publication 20050147131 of Greer, assigned to Nokia, which is incorporated herein by reference. As described therein, a small number of vocoder bits are “stolen” and used provide a low-rate data channel without appreciable effect on voice quality. Some systems, including UMTS, may permit separate simultaneous voice and data connections, in which case the technique of Greer may not be needed.

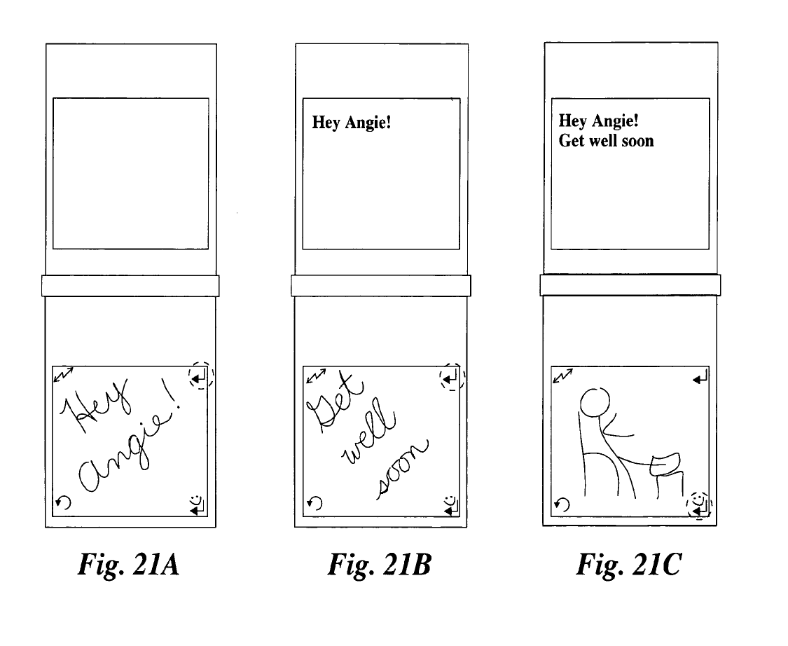

An illustration of mobile instant messaging using text and graphics entry in accordance with FIG. 18 is shown in FIGS. 21A, 21B and 21C. As shown in FIG. 21A, the user first writes “Hey Angie!” and activates the icon 1403 (FIG. 14). In response, the written text is recognized, displayed and sent to the remote user (Angie). As shown in FIG. 21B, the user then writes “Get well soon” and activates the icon 1403. The written text is recognized, displayed and sent to Angie. As shown in FIG. 21C, the user then draws a picture representing Angie's condition. The user activates the icon 1405. In response, the graphic is displayed (possibly in thumbnail form, although not shown) and sent to Angie.

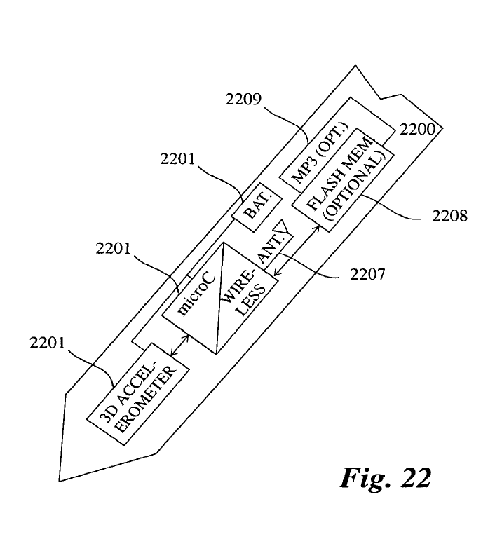

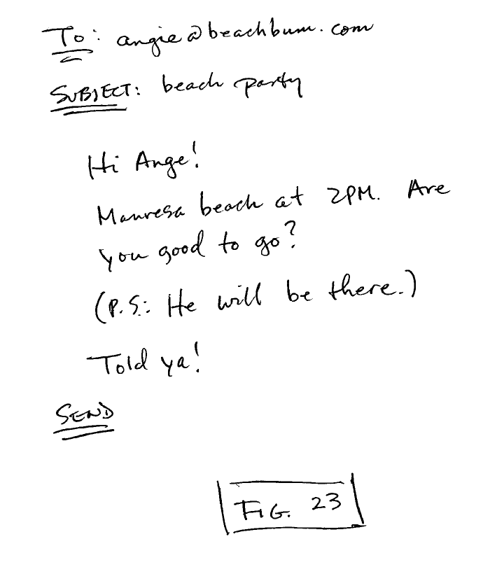

The foregoing method works well within the confines of the limited screen size of the device. These limitations may be overcome at least in part using a pen equipped with a 3D accelerometer and wireless communications capabilities. Such a pen 2200 is illustrated in FIG. 22. It includes a 3D accelerometer 2201, a microcontroller provided with wireless communications capabilities (e.g., Bluetooth, UWB, Zigbee, etc.) 2203, a battery 2205, and an antenna 2207. Mechanical features of the pen such as an ink reservoir are not shown. Optionally, one or more input buttons or other inputs to the microcontroller may he provided. The pen may also be provided with flash memory 2208 and a USB interface to enable it to function as a memory stick or even as an MP3 player (2209).

The pen is used with plain paper to interface to a mobile electronic device provided with similar wireless communications capabilities. The term “plain paper interface” may therefore be used to describe this manner of operation.

As a user uses the pen to write on a plain piece of paper, writing capture occurs through the mechanism of the 3D accelerometer and wireless communications. That is, data from the 3D accelerometer describing motion of the pen is wirelessly communication to the mobile electronic device (not shown). A recognizer may receive the input from the 3D accelerometer and perform handwriting recognition thereon. While the writing will typically be displayed on the main display of the mobile electronic device, the user will have less need to refer to the display except to resolve ambiguities in recognition. Commands may be input to the mobile electronic device through the plain paper interface using one or more signifiers. For example, double-underlining may be used to identify text as a command or as text having special significance for program operation.

Referring to FIG. 23, an example is shown of using plain paper interface to send an email. The user writes “TO”, upon which the mobile electronic device recognizes that the user wishes to send an email. The mobile electronic device prompts the user to enter an email address using an address book of the mobile electronic device, separate and apart from the plain paper interface. In the illustrated example, the desired address is not in the address book. The user therefore ignores the prompt and enters the desired address through the plain paper interface. The user may also enter “CC” addresses and the like in the same or similar manner. The user then writes “SUBJECT” followed by the subject of the email. The user then enters the text of the email. To attach an attachment, the user writes “ATTACH”. The mobile electronic device then prompts the user to select one or more attachments, separate and apart from the plain paper interface. Finally, the user writes “SEND”. The email is then sent.

Note that all of the features previously described (Instant Messaging Plus, Voice Plus, etc.) may be used together with plain paper interface methods, the principal difference being that writing capture occurs through the mechanism of the 3D accelerometer and wireless communications.

It will be appreciated by those of ordinary skill in the art that the present invention can be embodied in other specific forms without departing from the spirit or essential character thereof. The described embodiments are therefore considered in all respects to be illustrative and not restrictive. The scope of the invention is given by the appended claims, not the foregoing description, and all changes which come within the meaning and range of equivalents thereof are intended to be embraced therein.

What is claimed is:

1. A mobile electronic device, comprising:
a processor; and
a touch sensor coupled to the processor;
wherein the processor and the touch sensor are configured for:
detecting one of: a touch of a key area; and a touch of the key area followed by a touch inflection in which a digit used to activate the touch sensor is moved while in contact with the touch sensor; and
inputting one of first textual information in response to said touch alone and second textual information in response to said touch inflection.

2. A method of inputting text to a mobile electronic device using a touch sensor, comprising:
detecting one of: a touch of a key area; and a touch of the key area followed by a touch inflection in which a digit used to activate the touch sensor is moved while in contact with the touch sensor; and
inputting one of first textual information in response to said touch alone and second textual information in response to said touch inflection.
